(19) United States
(12) Patent Application Publication
(10) Pub. No.: US 2025/0118508 A1
(43) Pub. Date: Apr. 10, 2025

(54) Side conduction assembly for key switch

(71) Applicant: DONGGUAN CITY KAIHUA ELECTRONICS CO., LTD, Dongguan, Guangdong (CN)

(72) Inventors: Fuxi WU, Dongguan, Guangdong (CN); Qiancheng Hu, Dongguan, Guangdong (CN)

(21) Appl. No.: 18/293,733

(22) PCT Filed: Aug. 4, 2022
(86) PCT No.: PCT/CN2022/110166

§ 371 Date: Jan. 30, 2024

(30) Foreign Application Priority Data
Aug. 17, 2021 (CN) 202121924121.7

(51) Int. Cl. H01H 13/14; H01H 13/02

(52) U.S. Cl. CPC H01H 13/14; H01H 13/023

(57) ABSTRACT

The present utility model discloses a side conduction assembly for a key switch, comprising a PCB board and a plurality of side conduction structures fastened on the PCB board, wherein the side conduction structure comprises a housing, a guide core disposed on the housing, a movable plate disposed in the housing, and a static plate disposed in the housing; The utility model can conduct from the side to the external line, reduce the overall height, and implement an ultra-thin product.

### TECHNICAL FIELD

The present utility model relates to the field of key switches, and particularly relates to a side conduction assembly for a key switch.

### BACKGROUND ART

Key switches are mainly referred to as light-touch key switches, also called light-touch switches. The key switch is an electronic switch, which belongs to the category of electronic components. In use, a switch is switched on and the switch function is conducted when a pressure is applied to the operating direction of the switch under a condition satisfying an operating force. The switch is switched off when the pressure is removed. The internal structure of the key switch is switched on and off by means of a change in the force of a metal elastic piece. It is widely used in Bluetooth headsets, cash registers and some industrial equipment.

At present, the common key switches on the market mainly include components and parts, such as a base, an upper cover, a static plate, a movable plate and a button. An accommodating cavity is formed by the upper cover and the base. The movable plate and the static plate are arranged in the accommodating cavity. The elastic portions on the movable plate and the static plate extend downwards until contacting the external circuit board, so as to achieve the electrical connection with the external circuit board. Since the elastic portions of the movable plate and the static plate require a space to be extended downwards, a common key switch is generally made high in its entirety in order to reserve the space, which is not applicable to some ultra-thin keyboards and some industrial equipment. Moreover, such conventional key switches are basically provided directly on the required equipment. If there is a problem, it is difficult to disassemble and replace them.

### Summary of the Utility Model

In view of the above-mentioned deficiencies, the object of the present utility model is to provide a side conduction assembly for a key switch, which can conduct from the side to the external line, reduce the overall height, and implement an ultra-thin product.

The technical solutions adopted by the utility model to achieve the above-mentioned purpose are as follows.

A side conduction assembly for a key switch comprises a PCB board and a plurality of side conduction structures fastened on the PCB board, wherein the side conduction structure comprises a housing, a guide core disposed on the housing, a movable plate disposed in the housing, and a static plate disposed in the housing; the movable plate is pushed by the up-and-down movement of the guide core so as to control the contact and separation of the movable plate and the static plate, wherein the movable plate comprises a support arm of the movable plate which is integrally formed and is bent twice towards the outside of the side; the static plate comprises a support arm of the static plate which is integrally formed and bent twice towards the outside of the side; wherein the support arm of the movable plate is provided with a first bent portion of the movable plate bent to the outside of the side, and the first bent portion of the movable plate passes out of the housing and is electrically connected to the PCB board; and the support arm of the static plate is provided with a first bent portion of the static plate bent to the outside of the side, and the first bent portion of the static plate passes out of the housing and is electrically connected to the PCB board.

Further, the support arm of the movable plate is further provided with a second bent portion of the movable plate which is bent downwards and extends upwards, and the first bent portion of the movable plate is provided on the second bent portion of the movable plate; and the support arm of the static plate is further provided with a second bent portion of the static plate which is bent downwards and extends upwards, and the first bent portion of the static plate is disposed on the second bent portion of the static plate.

Further, the movable plate is further provided with an integrally formed fixing portion of the movable plate, a contact portion of the movable plate connected to one end of the fixing portion of the movable plate and a pushing portion of the movable plate connected to the contact portion of the movable plate, wherein the support arm of the movable plate is disposed at the other end of the fixing portion of the movable plate; and the static plate is further provided with a fixing portion of the static plate integrally formed, and a contact portion of the static plate connected to one end of the fixing portion of the static plate and matching the contact portion of the movable plate.

Further, one end of the contact portion of the movable plate close to the pushing portion of the movable plate is provided with at least one contact protrusion of the movable plate; one end of the contact portion of the static plate close to the pushing portion of the movable plate is provided with at least one contact protrusion of the static plate matching the contact protrusion of the movable plate; wherein the contact or separation between the contact protrusion of the movable plate and the contact protrusion of the static plate is controlled by the movement of the pushing portion of the movable plate in the left-right direction.

Further, the housing comprises a base and an upper cover covered on the base; a guide post is disposed on the base; an elastic member is sleeved on the guide post; the guide post sleeved with the elastic member is disposed on a lower end of the guide core; and the upper cover is exposed for being pressed from an upper end of the guide core.

Further, a mounting portion for mounting the movable plate and the static plate is formed on a side edge of the base; and a plurality of limit protrusions for fixing the movable plate and the static plate are formed in the mounting portion.

Further, a protruding port of the movable plate matching the support arm of the movable plate and a protruding port of the static plate matching the support arm of the static plate are disposed on the outer wall of the same side of the base; the first bent portion of the movable plate passes out of the protruding port of the movable plate and is electrically connected to the PCB board; and the first bent portion of the static plate passes out of the protruding port of the static plate and is electrically connected to the PCB board.

Further, an active groove is disposed on the mounting portion and located between the guide core and the pushing portion of the movable plate; an active block is disposed on the movable groove, and the active block is pressed against the pushing portion of the movable plate; and a push protrusion is formed on the guide core in a direction towards the active block.

Further, the base is further provided with a waterproof cover which is covered on the mounting portion.

Further, a light-emitting structure is further disposed on the other side edge of the base; the light-emitting structure comprises a first light-emitting terminal disposed on the other side edge of the base, a second light-emitting terminal disposed on the other side edge of the base and located beside the first light-emitting terminal, a terminal connecting plate disposed inside the other side edge of the base and connected to the first light-emitting terminal and the second light-emitting terminal, and a light-emitting element disposed on the terminal connecting plate; the first light-emitting terminal comprises a support arm of the first terminal which is integrally formed and is twice bent towards the outside of the side edge of the base, wherein the support arm of the first terminal is provided with a bent portion of the first terminal which is bent towards the outside of the side edge of the base, and the bent portion of the first terminal passes out of the base and is electrically connected to the PCB board; the second light-emitting terminal comprises a support arm of the second terminal which is integrally formed and is twice bent towards the outside of the side edge of the base, wherein the support arm of the second terminal is provided with a bent portion of the second terminal which is bent towards the outside of the side edge of the base, and the bent portion of the second terminal passes out of the base and is electrically connected to the PCB board.

The utility model has the following beneficial effects.
(1) By providing a support arm of the movable plate, a first bent portion of the movable plate is disposed on the support arm of the movable plate and is bent to the outside of the side, and the first bent portion of the movable plate is electrically connected to the PCB board, so that the conduction of the movable plate is conducted to the PCB board at the side edge, and it reduces the overall height of the movable plate, thereby achieving the light and thin movable plate. By providing a support arm of the static plate, a first bent portion of the static plate is disposed on the support arm of the static plate and is bent to the outside of the side, and the first bent portion of the static plate is electrically connected to the PCB board, so that the conduction of the static plate is conducted to the PCB board at the side edge, and it reduces the overall height of the static plate, thereby achieving the light and thin static plate. The combination of the movable plate and the static plate enables the product to conduct an external line from the side, reduces the overall height, and implement an ultra-thin product. By providing the movable plate and the static plate separately, the movable plate and the static plate may be separately disassembled and replaced, so that the replacement cost is reduced, and the service life of the static plate assembly is effectively improved. By fastening the integral lateral side conduction structure onto the PCB board, the purpose of easy disassembly is achieved, the replacement cost is further reduced and the service life of the product is improved.
(2) By providing a pushing portion of the movable plate, the pushing portion of the movable plate is bent towards the contact portion of the static plate, and the bent portion allows the power pushing portion to better receive the force from the active block, so as to drive the movable plate to contact and separate the contact portion of the static plate more quickly, thereby improving the efficiency of contacting and separating the movable plate and the static plate.
(3) A protruding port of the movable plate and a protruding port of the static plate are formed on the base, so as to facilitate the first bent portion of the movable plate passing out of the protruding port of the movable plate and electrically connecting same with the PCB board, and the first bent portion of the static plate passing out of the protruding port of the static plate and electrically connecting same with the PCB board, thereby improving the speed of the present assembly for conducting with the PCB board at the side edge and improving the efficiency of conducting.

A light-emitting structure is disposed in the base. When the housing is mounted on the PCB board, the bent portion of the first terminal passes out of the base and is electrically connected to the PCB board, and the bent portion of the second terminal passes out of the base and is electrically connected to the PCB board. Then, the terminal connecting plate connected to the first light-emitting terminal and the second light-emitting terminal conducts so as to brighten the light-emitting element disposed on the terminal connecting plate, thereby enabling the light-emitting structure to conduct with the PCB board from the side, reducing the overall height of the light-emitting structure, and achieving a light and thin light-emitting structure. In addition, by disposing the light-emitting structure, the purpose of indicating the conduction condition is achieved, the aesthetics of the component is increased, and the experience of using the component is improved.

The above mentioned is an overview of the technical solution of the utility model. The following is a further explanation of the utility model in combination with the attached drawings and detailed description.

### BRIEF DESCRIPTION OF THE DRAWINGS

FIG. 1 is a structurally schematic view of the utility model;

FIG. 2 is a schematic view of a side conduction structure;

FIG. 3 is a schematic view of a side conduction structure with a upper cover removed;

FIG. 4 is a schematic view of a side conduction structure with an upper cover and a waterproof cover removed;

FIG. 5 is an exploded view of the side conduction structure;

FIG. 6 is a schematic view showing a structure in which the movable plate and the static plate are in contact;

FIG. 7 is a cross-sectional view of the side conduction structure after a conduction core is pressed;

FIG. 8 is a structurally schematic view of a light-emitting element;

FIG. 9 is a top view of a light-emitting element;

In the drawings, 1, PCB board; 11, connection and placement port; 12, connection port of the movable plate; 13, connection port of the static plate; 2, side conduction structure; 21, housing; 211, base; 2111, guide post; 2112, mounting portion; 21121, limit protrusion; 2113, fastener; 212; upper cover; 213, extension port of the movable plate; 214, extension port of the static plate; 215, active slot; 22, guide core; 221, push protrusion; 23, movable plate; 231, support arm of the movable plate; 2311, first bent portion of the movable plate; 2312, second bent portion of the movable plate; 232, fixing portion of the movable plate; 233, contact portion of the movable plate; 2331, contact protrusion of the movable plate; 234, pushing portion of the movable plate; 24, static plate; 241, support arm of the static plate; 2411, first bent portion of the static plate; 2412, second bent portion of the static plate; 242, fixing portion of the static plate; 2421, fixed port; 243, contact portion of the static plate; 2431, contact protrusion of the static plate; 25, elastic member; 26, active block; 27, waterproof cover; 3, light-emitting structure; 31, first light-emitting terminal; 311, support arm of the first terminal; 3111, bent portion of the first terminal; 3112, bent portion of the third terminal; 312, fixing portion of the first terminal; 313, connection portion of the first terminal; 32, second light-emitting terminal; 321, support arm of the second terminal; 3211, bent portion of the second terminal; 3212, fourth terminal bent portion; 322, fixing portion of the second terminal; 323, connection portion of the second terminal; 33, terminal connecting plate; 331, connection port of the first terminal; 332, connection port of the second terminal; 34, light-emitting element.

### DETAILED DESCRIPTION

In order to further clarify the technical means and effects adopted by the present utility model to achieve the intended purpose, a detailed description of specific examples of the present utility model will be given below with reference to the accompanying drawings and preferred examples.

### Example 1

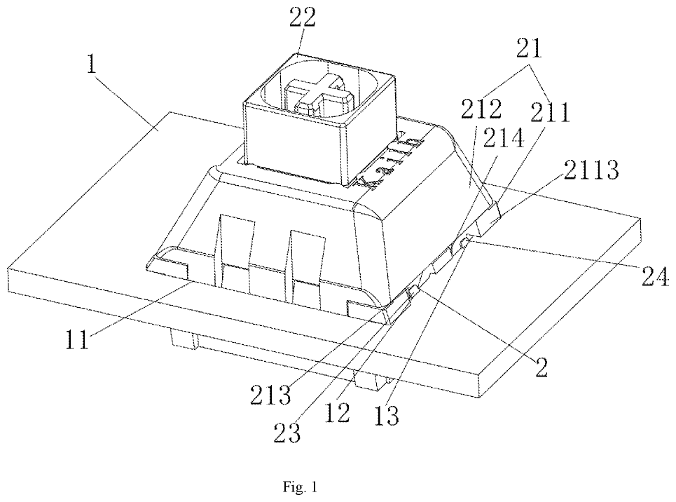

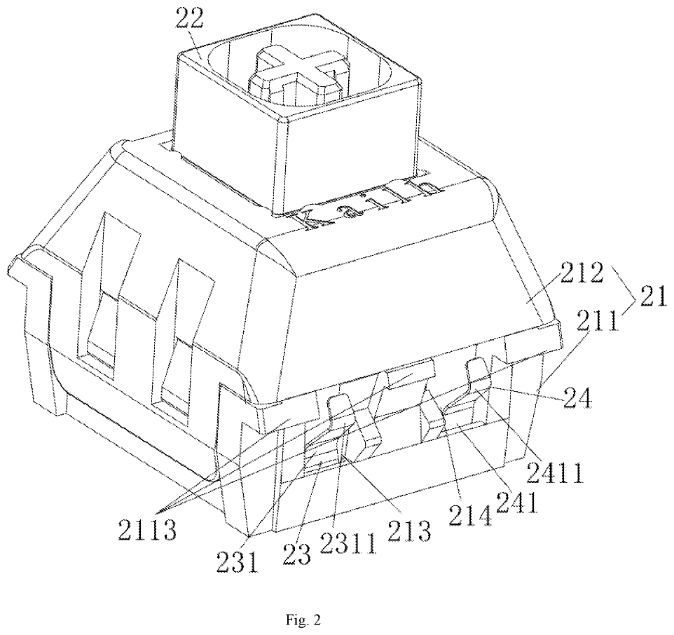

With reference to FIGS. 1 to 7, the example of the present utility model provides a side conduction assembly for a key switch, including a PCB board 1 and a plurality of side conduction structures 2 fastened on the PCB board 1. The side conduction structures 2 include a housing 21, a guide core 22 disposed on the housing 21, a movable plate 23 disposed in the housing 21, and a static plate 24 disposed in the housing 21. The movable plate 23 is pushed by the up-and-down movement of the guide core 22 so as to control the contact and separation of the movable plate 23 and the static plate 24. The movable plate 23 includes a support arm 231 of the movable plate which is integrally formed and is bent twice to the outside of the side. The static plate 24 includes a support arm 241 of the static plate which is integrally formed and is bent twice to the outside of the side. The support arm 231 of the movable plate is provided with a first bent portion 2311 of the movable plate which is bent to the outside of the side. The first bent portion 2311 of the movable plate passes out of the housing 21 and is electrically connected to the PCB board 1. The support arm 241 of the static plate is provided with a first bent portion 2411 of the static plate which is bent to the outside of the side. The first bent portion 2411 of the static plate passes out of the housing 21 and is electrically connected to the PCB board 1.

By providing the support arm 231 of the movable plate, the first bent portion 2311 of the movable plate is disposed on the support arm of the movable plate and is bent to the outside of the side, and the first bent portion 2311 of the movable plate 1 is electrically connected to the PCB board, so that the conduction of the movable plate 23 is conducted to the PCB board 1 at the side edge, and it reduces the overall height of the movable plate 23, thereby achieving the light and thin movable plate 23. By providing the support arm 241 of the static plate, the first bent portion 2411 of the static plate is disposed on the support arm of the static plate and is bent to the outside of the side, and the first bent portion 2411 of the static plate is electrically connected to the PCB board 1, so that the conduction of the static plate 24 is conducted to the PCB board 1 at the side edge, and it reduces the overall height of the static plate 24, thereby achieving the light and thin static plate 24. The combination of the movable plate 23 and the static plate 24 enables the product to conduct an external line from the side, reduces the overall height, and implement an ultra-thin product. By providing the movable plate 23 and the static plate 24 separately, the movable plate 23 and the static plate 24 may be separately disassembled and replaced, so that the replacement cost is reduced, and the service life of the movable plate 23 and the static plate 24 is effectively improved. By fastening the integral lateral side conduction structure 2 onto the PCB board 1, the purpose of easy disassembly is achieved, the replacement cost is further reduced and the service life of the product is improved.

With regard to the specific structure of the support arm 231 of the movable plate, as shown in FIGS. 1-6, the support arm 231 of the movable plate is further provided with a second bent portion 2312 of the movable plate which is bent downwards and extends upwards, and the first bent portion 2311 of the movable plate is provided on the second bent portion 2312 of the movable plate. Preferably, the second bent portion of the movable plate 2312 is downwardly bent in a U-shape, and the height of the bent portion is low. By providing the second bent portion of the movable plate 2312 which is bent downwards and extends upward to cooperate with the first bent portion 2311 of the movable plate which is disposed on the second bent portion of the movable plate 2312 and extends to the side, the support arm 231 of the movable plate is better extended to the side, so that the movable plate 23 may be conducted to the side with the PCB board 1, and it reduces the overall height of the movable plate 23, thereby achieving the light and thin movable plate 23.

With regard to the specific structure of the support arm 241 of the static plate, as shown in FIGS. 1-6, the support arm 241 of the static plate is further provided with a second bent portion 2412 of the static plate which is bent downwards and extends upwards, and the first bent portion 2411 of the static plate is disposed on the second bent portion 2412 of the static plate. Preferably, the second bent portion 2412 of the static plate is U-shaped and has a wider bottom and a lower bending height. By providing the second bent portion 2412 of the static plate which is bent downwards and extends upwards to cooperate with the first bent portion 2411 of the static plate which is disposed on the second bent portion 2412 of the static plate and extends to the side, the support arm 241 of the static plate is better extended to the side, so as to achieve the conduction of the static plate 24 to the side with the PCB board 1, and it reduces the overall height of the static plate 24, thereby achieving the light and thin static plate 24. In addition, the bottom of the second bent portion 2412 of the static plate is wider, so that mis-contact with the movable plate 23 is effectively prevented, thereby ensuring the conduction accuracy of the present assembly.

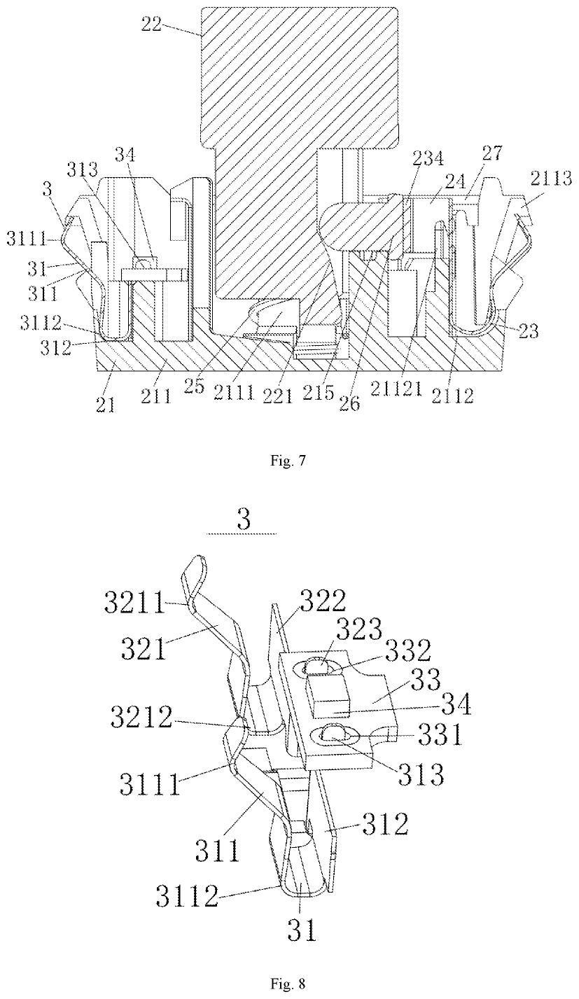

With regard to the specific structure of the movable plate 23, as shown in FIGS. 1-6, the movable plate 23 is further provided with an integrally formed fixing portion 232 of the movable plate, a contact portion 233 of the movable plate connected to one end of the fixing portion 232 of the movable plate and a pushing portion 234 of the movable plate connected to the contact portion 233 of the movable plate. The support arm 231 of the movable plate is disposed at the other end of the fixing portion 232 of the movable plate. The movable plate 23 is fixed to the housing 21 by a fixing portion 232 of the movable plate, as shown in FIG. 7, and the pushing portion 234 of the movable plate, under the control of the active block 26 described below, makes a contact portion 233 of the movable plate contact with or separate from a contact portion 243 of the static plate described below, thereby making the present assembly conductive or non-conductive. Specifically, when the pushing portion 234 of the movable plate receives a pushing force in the direction of the support arm 231 of the movable plate given by the active block 26 described below, the pushing portion 234 of the movable plate drives the contact portion 233 of the movable plate connected thereto to move in the direction of the support arm of the movable plate 21. Meanwhile, the contact portion 233 of the movable plate is separated from the contact portion 243 of the static plate described below, thereby achieving the purpose of non-conduction between the movable plate 23 and the static plate 24. When the active block 26 described below does not give a pushing force, the contact portion 233 of the movable plate moves in the direction of the contact portion 243 of the static plate described below under the elastic restoring force of the movable plate 23 itself, and comes into contact with the contact portion 243 of the static plate described below, so as to achieve the conduction between the movable plate 23 and the static plate 24, further achieving the power on/off safety of the present assembly, and improving the efficiency of conduction.

By providing the movable plate 23 and the static plate 24 respectively, the movable plate 23 and the static plate 24 may be separately disassembled and replaced, reducing the replacement cost and effectively improving the service life of the assembly.

Preferably, the contact portion 233 of the movable plate has a lateral U-shape away from the fixing portion 242 of the static plate to prevent the contact portion 233 of the movable plate from erroneously contacting the fixing portion 242 of the static plate. The fixing portion 232 of the movable plate is in a longitudinal plate shape and spaced apart from the fixing portion 242 of the static plate so as to prevent the fixing portion 232 of the movable plate from erroneously contacting the fixing portion 242 of the static plate.

In order to better allow the pushing portion 234 of the movable plate to receive the pushing force of the active block 26 described below, as shown in FIGS. 1 to 7, the pushing portion 234 of the movable plate is bent towards the contact portion 243 of the static plate. By bending the pushing portion 234 of the movable plate towards the contact portion 243 of the static plate, which makes the pushing portion 234 of the movable plate better contact with the active block 26 described below, the mating degree of the pushing portion on the key switch with the active block 26 described below is improved. The pushing accuracy of the pushing portion 234 of the movable plate is improved, and the working efficiency of the present assembly is further improved.

With regard to the specific structure of the static plate 24, as shown in FIGS. 1-6, the static plate 24 is further provided with an integrally formed fixing portion 242 of the static plate, and a contact portion 243 of the static plate connected to one end of the fixing portion 242 of the static plate and matching the contact portion 233 of the movable plate. The static plate 24 is fixed to the housing 21 via a fixing portion 242 of the static plate, and the contact portion 243 of the static plate connected to the fixing portion 242 of the static plate is fixed to the housing 21 at the same time, thereby ensuring that the contact portion 243 of the static plate is not easy to move or fall off during use, reducing the false contact between the contact portion 243 of the static plate and the contact portion 233 of the movable plate, and ensuring the normal conduction and disconnection of the present assembly.

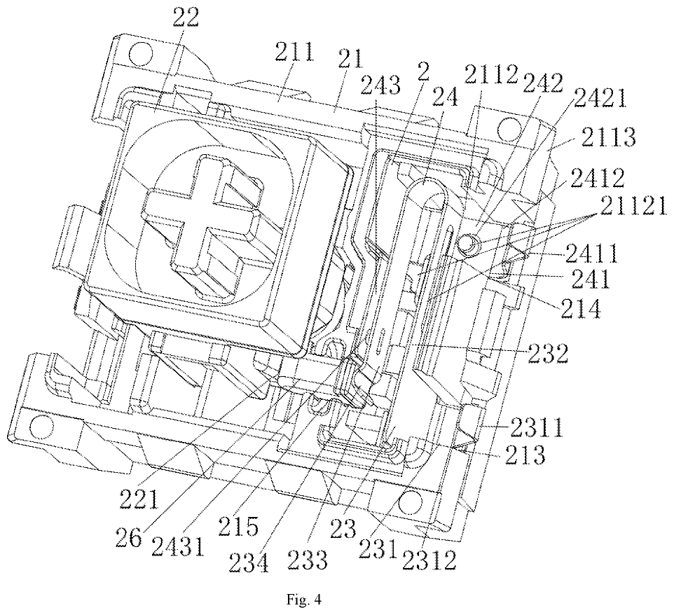

In order to better enable the contact portion 233 of the movable plate and the contact portion 243 of the static plate to conduct, as shown in FIGS. 4-6, the contact portion 243 of the static plate 24 is bent towards the direction of the contact portion 233 of the movable plate, thereby reducing the distance between the contact portion 243 of the static plate and the contact portion 233 of the movable plate, so that the contact portion 243 of the static plate and the contact portion 233 of the movable plate may conduct more quickly in the case of requiring conduction, further improving the conduction speed and conduction efficiency of the present assembly.

With regard to the specific contact mode between the contact portion 233 of the movable plate and the contact portion 243 of the static plate, as shown in FIGS. 4-6, one end of the contact portion 233 of the movable plate close to the pushing portion 234 of the movable plate is provided with at least one contact protrusion 2331 of the movable plate. One end of the contact portion 243 of the static plate close to the pushing portion 234 of the movable plate is provided with at least one contact protrusion 2431 of the static plate matching the contact protrusion 2331 of the movable plate. The contact or separation between the contact protrusion 2331 of the movable plate and the contact protrusion 2431 of the static plate is controlled by the movement of the pushing portion 234 of the movable plate in the left-right direction. By providing a contact protrusion 2331 of the movable plate and a contact protrusion 2431 of the static plate for contact and conduction, the risk of mis-contact at other positions of the contact portion 233 of the movable plate and the contact portion 243 of the static plate is reduced. Also, the two protrusions are oppositely arranged, and the conduction distance is reduced. The conduction speed is further improved, and the conduction efficiency is improved.

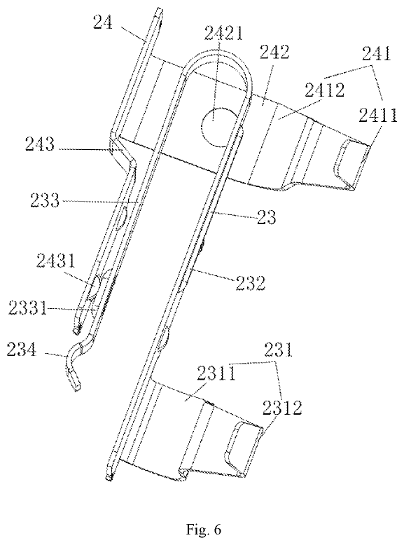

Preferably, the contact protrusion 2331 of the movable plate has a laterally disposed semi-cylindrical shape, and as shown in FIG. 6, the contact protrusion 2431 of the static plate has a longitudinally disposed semi-cylindrical shape. The lateral and longitudinal designs extend the contact range of the contact protrusion 2431 of the static plate and the contact protrusion 2331 of the movable plate, improve the contact efficiency of the movable plate 23 and the static plate 24, thereby further improving the contact fit of the assembly and improving the working efficiency of the assembly.

With regard to the specific structure of the housing 21, as shown in FIGS. 1-5, the housing 21 includes a base 211 and an upper cover 212 covered on the base 211. A guide post 2111 is disposed on the base 211. An elastic member 25 is sleeved on the guide post 2111. The guide post 2111 sleeved with the elastic member 25 is disposed on a lower end of the guide core 22. The upper cover 212 is exposed for being pressed from an upper end of the guide core 22. By providing a base 211 and an upper cover 212 covered on the base 211, an accommodating cavity is formed. The movable plate 23, the static plate 24 and the guide core 22 are disposed in the accommodating cavity, thereby effectively protecting the parts such as the movable plate 23 and the static plate 24 and improving the service life of the parts such as the movable plate 23 and the static plate 24. By providing a guide post 2111, the guide post 2111 is sleeved with an elastic member 25, the lower end of the guide core 22 is disposed on the guide post 2111 sleeved with the elastic member 25, and the upper end of the guide core 22 is exposed for being pressed from the upper cover 212, so that a user may push the guide core 22 to control the conduction state of the movable plate 23 and the static plate 24 by directly pressing the guide core 22. When the user does not need to conduct the present assembly, by means of the elastic restoring force provided by the elastic member 25, the guide core 22 may spring up and return to the non-pressed state. At the same time, the active block 26 described below is driven to push the pushing portion 234 of the movable plate, so that the movable plate 23 and the static plate 24 are separated, so as to achieve the purpose of non-conduction of the present assembly. The operation thereof is simple and convenient, and it effectively improves the conduction efficiency of the present assembly and enhances the experience of using the present assembly.

Preferably, the elastic member 25 is a spring.

In order to better fasten the housing 21 to the PCB board, as shown in FIGS. 1-3, a plurality of fasteners 2113 are disposed around the upper end of the base 211, and the base 211 is fastened to the PCB board via the fasteners 2113. By disposing a plurality of fasteners 2113 on the peripheral surface of the upper end of the base 211, the assembly is easily disassembled and replaced on the PCB board. The disassembly speed of the assembly is improved, and the replacement cost of this assembly is reduced.

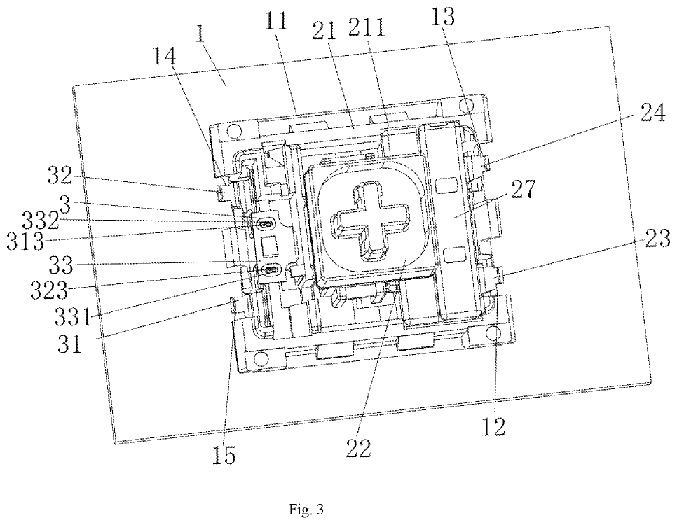

With regard to the method for fixing the movable plate 23 and the static plate 24 on the base 211, as shown in FIG. 3, a mounting portion 2112 for mounting the movable plate 23 and the static plate 24 is formed on a side edge of the base 211. A plurality of limit protrusions 21121 for fixing the movable plate 23 and the static plate 24 are formed in the mounting portion 2112. The fixing portion 232 of the movable plate is clamped and fixed by two limit protrusions 21121. the fixing portion 242 of the static plate is provided with a fixed port 2421 through which the limit protrusion 21121 fits for passing. The other limit protrusion 21121 passes through the fixed port 2421 to fix the fixing portion 242 of the static plate on the base 211, so as to achieve the purpose of fixing the movable plate 23 and the static plate 24 on the base 211. It further improves the stability and firmness of the present assembly, effectively prevents the movable plate 23 and the static plate 24 from shifting, falling off and mis-touching, and improves the working efficiency of the present assembly.

With regard to the specific structure of the movable plate 23 and the static plate 24 passing out of the base 211 to be electrically connected to the PCB board 1, as shown in FIGS. 1-4, a protruding port 213 of the movable plate matching the support arm 231 of the movable plate and a protruding port 214 of the static plate matching the support arm 241 of the static plate are disposed on the outer wall of the same side of the base 211. The first bent portion of the movable plate 2311 passes out of the protruding port 213 of the movable plate and is electrically connected to the PCB board 1. The first bent portion of the static plate passes out of the protruding port 214 of the static plate and is electrically connected to the PCB board 1. By providing a protruding port of the movable plate 213 on the outer wall of the same side of the base 211, it facilitates the first bent portion 2311 of the movable plate passing out of the protruding port of the movable plate 213 and electrically connecting same with the PCB board 1. The speed of contact between the movable plate and the PCB is improved, and the conduction efficiency of the movable plate is further improved. By providing a protruding port of the static plate 214 on the outer wall of the same side of the base 211, it facilitates the first bent portion 2411 of the static plate passing out of the protruding port of the static plate 214 and electrically connecting same with the PCB board 1. The speed of contact between the static plate and the PCB is improved, and the conduction efficiency of the static plate is further improved.

With regard to the specific structure of the PCB board 1, as shown in FIGS. 1-3, the PCB board 1 is provided with a connection and placement port 11 matching the housing 21. The connection and placement port 11 is provided with a connection port 12 of the movable plate matching the first bent portion 2311 of the movable plate and a connection port 13 of the static plate matching the first bent portion 2411 of the static plate. The bent portion of the first bent portion 2311 of the movable plate is in contact with the connection port 12 of the movable plate, so as to achieve the conductive connection between the movable plate 23 and the PCB board 1. The bent portion of the first bent portion 2411 of the static plate is in contact with the connection port of the static plate 13, so as to achieve the conductive connection between the static plate 24 and the PCB board 1. By disposing the PCB board 1 with the connection and placement port 11 matching the housing 21, the side conduction structure 2 is conveniently fastened onto the PCB board 1 and electrically connected to the PCB board 1. The structure is simple and the operation is convenient. The speed of disassembling and replacing the side conduction structure 2 from the PCB board 1 is improved, and the practicability of the present assembly is further improved. By disposing the connection port 12 of the movable plate matching the first bent portion 2311 of the movable plate and the connection port 13 of the static plate matching the first bent portion 2411 of the static plate on the connection and placement port 11, the matching degree of the movable plate 23 and the static plate 24 to be electrically connected to the PCB board 1 is improved, thereby improving the conduction efficiency of the side conduction structure and the PCB board 1.

With regard to the specific method of the guide core 22 acting on the pushing portion 234 of the movable plate, as shown in FIGS. 4-7, an active groove 215 is disposed on the mounting portion 2112 and located between the guide core 22 and the pushing portion 234 of the movable plate. An active block 26 is disposed on the movable groove 215. The active block 26 is pressed against the pushing portion 234 of the movable plate. A push protrusion 221 is formed on the guide core 22 in a direction towards the active block 26. Preferably, the push protrusion 221 is inclined downwards by 45 degrees towards one side of the active block 26.

As shown in FIG. 7, when the guide core 22 is pressed down, the push protrusion 221 on the guide core 22 moves downwards at the same time. The inclined surface on the push protrusion 221 is separated from the active block 26. Due to the elastic restoring force of the movable plate 23 itself, the contact portion 233 of the movable plate rebounds to a state where the contact portion 243 of the static plate contacts. The active block 26 is driven synchronously by the pushing portion 234 of the movable plate, so that the active block 26 moves laterally left and right in the direction of the guide core 22. Thus, the active block 26 is in a state where it is separated from the push protrusion 221 on the guide core 22 and located above the push protrusion 221. When the user does not press the guide core 22, due to the elastic restoring force of the elastic member 25, the guide core 22 disposed above the elastic member 25 is driven to move upwards and reset. At this time, the push protrusion 221 on the guide core 22 moves upwards synchronously and is pressed against the active block 26, so that the active block 26 moves in the direction of the pushing portion 234 of the movable plate. At this time, the pushing portion 234 of the movable plate, pushed by the active block 26, drives the contact portion 233 of the movable plate connected thereto to be separated from the contact portion 243 of the static plate, thereby achieving the purpose of non-conduction between the movable plate 23 and the static plate 24. By disposing the active block 26 to match the push projection 221 on the guide core 22, the precision of the fit between the guide core 22 and the movable plate is improved, further improving the reaction sensitivity of the present assembly.

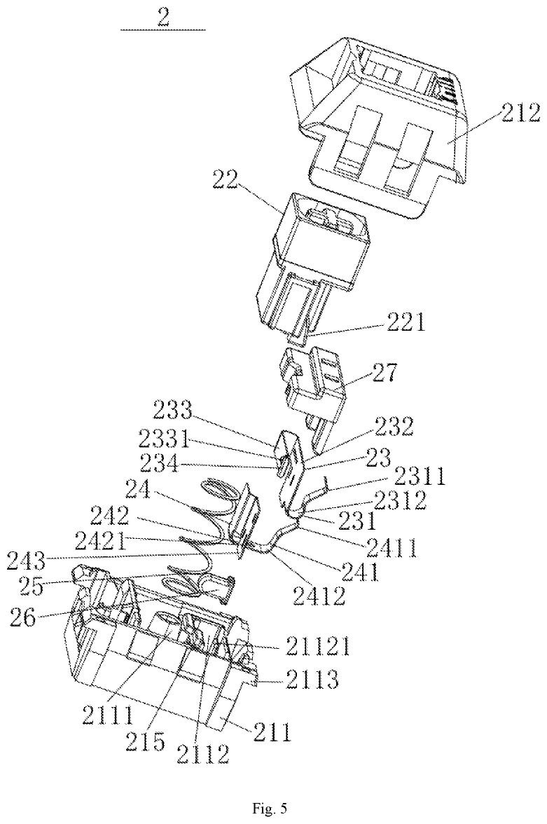

In order to prevent the movable plate 23 and the static plate 24 from being corroded due to water inflow, as shown in FIGS. 3 and 5, the base 211 is further provided with a waterproof cover 27 which is covered on the mounting part 2112. By disposing the waterproof cover 27, the waterproof cover 27 and the mounting portion 2112 form a waterproof space, and the movable plate 23 and the static plate 24 are disposed in the waterproof space, thereby effectively protecting the movable plate 23 and the static plate 24 from corrosion due to water inflow, and improving the service life of the present assembly.

### Example 2

In the first example, the structure of the top cover board assembly is described. In the present example, the differences from Example 1 will be mainly described, and the description of the same structure will not be repeated in the present example.

As shown in FIGS. 3 and 8-9, the main difference between Example 2 and Example 1 is that a light-emitting structure 3 is further disposed on the other side edge of the base 211. The light-emitting structure 3 includes a first light-emitting terminal 31 disposed on the other side edge of the base 211, a second light-emitting terminal 32 disposed on the other side edge of the base 211 and located beside the first light-emitting terminal 31, a terminal connecting plate 33 disposed inside the other side edge of the base 211 and connected to the first light-emitting terminal 31 and the second light-emitting terminal 32, and a light-emitting element 34 disposed on the terminal connecting plate 33. The first light-emitting terminal 31 includes a support arm 311 of the first terminal which is integrally formed and is twice bent towards the outside of the side edge of the base 211. The support arm 311 of the first terminal is provided with a bent portion 3111 of the first terminal which is bent towards the outside of the side edge of the base 211. The bent portion 3111 of the first terminal passes out of the base 211 and is electrically connected to the PCB board 1. The second light-emitting terminal 32 includes a support arm 321 of the second terminal which is integrally formed and is twice bent towards the outside of the side edge of the base 211. The support arm 321 of the second terminal is provided with a bent portion 3211 of the second terminal which is bent towards the outside of the side edge of the base 211. The bent portion 3211 of the second terminal passes out of the base 211 and is electrically connected to the PCB board 1.

A light-emitting structure 3 is disposed in the base 211. When the housing is mounted on the PCB board 1, the bent portion 3111 of the first terminal passes out of the base 211 and is electrically connected to the PCB board 1, and the bent portion 3211 of the second terminal passes out of the base 211 and is electrically connected to the PCB board 1. Then, the terminal connecting plate 33 connected to the first light-emitting terminal 31 and the second light-emitting terminal 32 conducts so as to brighten the light-emitting element 34 disposed on the terminal connecting plate 33, thereby enabling the light-emitting structure 3 to conduct with the PCB board 1 from the side, reducing the overall height of the light-emitting structure 3, and achieving a light and thin light-emitting structure 3. In addition, by disposing the light-emitting structure 3, the purpose of indicating the conduction condition is achieved, the aesthetics of the component is increased, and the experience of using the component is improved.

Preferably, the light-emitting element 34 is an LED lamp.

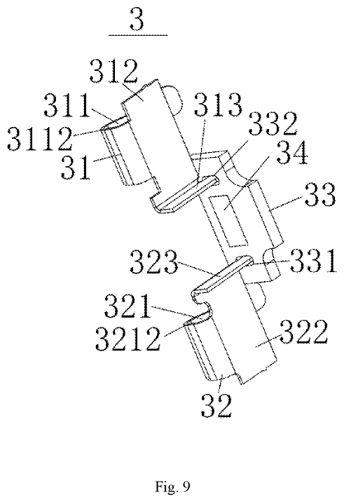

With regard to the specific structure of the support arm 311 of the first terminal, as shown in FIGS. 8 and 9, the support arm 311 of the first terminal is further provided with a bent portion 3112 of the third terminal which is bent downwards and extends upwards, and the bent portion 3111 of the first terminal is disposed on the bent portion 3112 of the third terminal. Preferably, the bent portion 3112 of the third terminal is downwardly bent in a U-shape, and the height of the bent portion is low. By providing the bent portion 3112 of the third terminal which is bent downwards and extends upwards to cooperate with the bent portion 3111 of the first terminal which is disposed on the bent portion 3112 of the third terminal and extends to the side, the support arm 311 of the first terminal is better extended to the side, so as to achieve the conduction of the first light-emitting terminal 31 to the PCB board 1 at the other side. It reduces the overall height of the first light-emitting terminal 31, thereby achieving a light and thin first light-emitting terminal 31.

With regard to the specific structure of the support arm 321 of the second terminal, as shown in FIGS. 8 and 9, the support arm 321 of the second terminal is further provided with a bent portion 3212 of the fourth terminal which is bent downwards and extends upwards, and the bent portion 3211 of the second terminal is disposed on the bent portion 3212 of the fourth terminal. Preferably, the bent portion 3212 of the fourth terminal is bent downwards in a U-shape, and the height of the bent portion is low. By providing the bent portion 3212 of the fourth terminal which is bent downwards and extends upwards to cooperate with the bent portion 3211 of the second terminal which is disposed on the bent portion 3212 of the fourth terminal and extends to the side, the support arm 321 of the second terminal is better extended to the side, so as to achieve the conduction of the second light-emitting terminal 32 to the PCB board 1 at the other side. It reduces the overall height of the second light-emitting terminal 32, thereby achieving a light and thin second light-emitting terminal 32.

With regard to the specific structure of the first light-emitting terminal 31, as shown in FIGS. 8 and 9, the first light-emitting terminal 31 is further provided with a fixing portion 312 of the first terminal which is integrally formed, and a connection portion 313 of the first terminal which is connected to the fixing portion 312 of the first terminal and extends upwards into the terminal connecting plate 33. The support arm of the first terminal is disposed on the fixing portion 312 of the first terminal, and the fixing portion 312 of the first terminal is disposed on the base 211. By disposing the fixing portion 312 of the first terminal to be fixed on the base 211, the first light-emitting terminal 31 is fixed on the base 211 so as to prevent the first light-emitting terminal 31 from moving or falling off from the base 211, thereby ensuring the stable cooperation between the first light-emitting terminal 31 and each component and ensuring the light-emitting effect of the light-emitting assembly 3.

With regard to the specific structure of the second light-emitting terminal 32, as shown in FIGS. 8 and 9, the second light-emitting terminal 32 is further provided with a fixing portion of the second terminal 322 which is integrally formed, and a connection portion 323 of the second terminal which is connected to the fixing portion of the second terminal 322 and extends upwards into the terminal connecting plate 33. The support arm 321 of the second terminal is disposed on the fixing portion of the second terminal 322, and the fixing portion of the second terminal 322 is disposed on the base 211. By disposing the fixing portion of the second terminal 322 to be fixed on the base 211, the second light-emitting terminal 32 is fixed on the base 211 so as to prevent the second light-emitting terminal 32 from moving or falling off from the base 211, thereby ensuring the stable cooperation between the second light-emitting terminal 32 and each component and ensuring the light-emitting effect of the light-emitting assembly 3.

With regard to the specific connection manner of the terminal connecting plate 33 to the first light-emitting terminal 31 and the second light-emitting terminal 32, as shown in FIGS. 8 to 9, the terminal connecting plate 33 is provided with a first terminal 331 of the connection port matching the connection portion 313 of the first terminal and a connection port 332 of the second terminal matching the connection portion 323 of the second terminal. The connection portion 313 of the first terminal is matingly inserted into the first terminal 331 of the connection port, so that the first light-emitting terminal 31 and the terminal connecting plate 33 conduct. The connection portion 323 of the second terminal is inserted into the connection port 332 of the second terminal so as to realize the conduction of the second light-emitting terminal 32 to the terminal connecting plate 33, thereby further improving the conduction efficiency of the terminal connecting plate 33 to the first light-emitting terminal 31 and the second light-emitting terminal 32.

With regard to the connection mode between the PCB board 1 and the light-emitting structure 3, as shown in FIG. 3, a conducting port 14 of the first terminal matching the bent portion 3111 of the first terminal and a conducting port 15 of the second terminal matching the bent portion of the second terminal 3211 are disposed on the connection and placement port 11. The bent portion of the bent portion 3111 of the first terminal is in contact with the conducting port 14 of the first terminal, and the first light-emitting terminal 31 is conductively connected to the PCB board 1 on the side. The bent portion of the bent portion of the second terminal 3211 is in contact with the second terminal conduction port 15, so as to realize the conductive connection between the second light-emitting terminal 32 and the PCB board 1 at the side, thereby further improving the conduction speed of the present assembly and reducing the time for disassembly and replacement between the present assembly and the PCB board 1.

It should be noted herein that the side conduction assembly of the key switch disclosed in the present utility model improves the specific structure, but the specific control mode is not an innovation point of the present utility model. The PCB board and other components involved in the present utility model may be common standard components or components known to a person skilled in the art, and the structure, principle and control method thereof are all known to a person skilled in the art by a technical manual or conventional experimental methods.

In the description above, only the preferred examples of the utility model has been described, and the technical scope of the utility model is not limited in any way. Therefore, other structures obtained by adopting the same or similar technical features as those of the above examples of the utility model are within the scope of the utility model.

1. A side conduction assembly for a key switch, comprising a PCB board and a plurality of side conduction structures fastened on the PCB board, wherein the side conduction structure comprises a housing, a guide core disposed on the housing, a movable plate disposed in the housing, and a static plate disposed in the housing; the movable plate is pushed by the up-and-down movement of the guide core so as to control the contact and separation of the movable plate and the static plate, wherein the movable plate comprises a support arm of the movable plate which is integrally formed and is bent twice towards the outside of the side; the static plate comprises a support arm of the static plate which is integrally formed and bent twice towards the outside of the side; wherein the support arm of the movable plate is provided with a first bent portion of the movable plate bent to the outside of the side, and the first bent portion of the movable plate passes out of the housing and is electrically connected to the PCB board; and the support arm of the static plate is provided with a first bent portion of the static plate bent to the outside of the side, and the first bent portion of the static plate passes out of the housing and is electrically connected to the PCB board.

2. The side conduction assembly for the key switch according to claim 1, wherein the support arm of the movable plate is further provided with a second bent portion of the movable plate which is bent downwards and extends upwards, and the first bent portion of the movable plate is provided on the second bent portion of the movable plate; and the support arm of the static plate is further provided with a second bent portion of the static plate which is bent downwards and extends upwards, and the first bent portion of the static plate is disposed on the second bent portion of the static plate.

3. The side conduction assembly for the key switch according to claim 1, wherein the movable plate is further provided with an integrally formed fixing portion of the movable plate, a contact portion of the movable plate connected to one end of the fixing portion of the movable plate and a pushing portion of the movable plate connected to the contact portion of the movable plate, wherein the support arm of the movable plate is disposed at the other end of the fixing portion of the movable plate; and the static plate is further provided with a fixing portion of the static plate integrally formed, and a contact portion of the static plate connected to one end of the fixing portion of the static plate and matching the contact portion of the movable plate.

4. The side conduction assembly for the key switch according to claim 3, wherein one end of the contact portion of the movable plate close to the pushing portion of the movable plate is provided with at least one contact protrusion of the movable plate; one end of the contact portion of the static plate close to the pushing portion of the movable plate is provided with at least one contact protrusion of the static plate matching the contact protrusion of the movable plate; wherein the contact or separation between the contact protrusion of the movable plate and the contact protrusion of the static plate is controlled by the movement of the pushing portion of the movable plate in the left-right direction.

5. The side conduction assembly for the key switch according to claim 3, wherein the housing comprises a base and an upper cover covered on the base; a guide post is disposed on the base;
an elastic member is sleeved on the guide post; the guide post sleeved with the elastic member is disposed on a lower end of the guide core; and the upper cover is exposed for being pressed from an upper end of the guide core.

6. The side conduction assembly for the key switch according to claim 5, wherein a mounting portion for mounting the movable plate and the static plate is formed on a side edge of the base; and a plurality of limit protrusions for fixing the movable plate and the static plate are formed in the mounting portion.

7. The side conduction assembly for the key switch according to claim 6, wherein a protruding port of the movable plate matching the support arm of the movable plate and a protruding port of the static plate matching the support arm of the static plate are disposed on the outer wall of the same side of the base; the first bent portion of the movable plate passes out of the protruding port of the movable plate and is electrically connected to the PCB board; and the first bent portion of the static plate passes out of the protruding port of the static plate and is electrically connected to the PCB board.

8. The side conduction assembly for the key switch according to claim 6, wherein an active groove is disposed on the mounting portion and located between the guide core and the pushing portion of the movable plate; an active block is disposed on the movable groove, and the active block is pressed against the pushing portion of the movable plate; and a push protrusion is formed on the guide core in a direction towards the active block.

9. The side conduction assembly for the key switch according to claim 6, wherein the base is further provided with a waterproof cover which is covered on the mounting portion.

10. The side conduction assembly for the key switch according to claim 5, wherein a light-emitting structure is further disposed on the other side edge of the base; the light-emitting structure comprises a first light-emitting terminal disposed on the other side edge of the base, a second light-emitting terminal disposed on the other side edge of the base and located beside the first light-emitting terminal, a terminal connecting plate disposed inside the other side edge of the base and connected to the first light-emitting terminal and the second light-emitting terminal, and a light-emitting element disposed on the terminal connecting plate; the first light-emitting terminal comprises a support arm of the first terminal which is integrally formed and is twice bent towards the outside of the side edge of the base, wherein the support arm of the first terminal is provided with a bent portion of the first terminal which is bent towards the outside of the side edge of the base, and the bent portion of the first terminal passes out of the base and is electrically connected to the PCB board; the second light-emitting terminal comprises a support arm of the second terminal which is integrally formed and is twice bent towards the outside of the side edge of the base, wherein the support arm of the second terminal is provided with a bent portion of the second terminal which is bent towards the outside of the side edge of the base, and the bent portion of the second terminal passes out of the base and is electrically connected to the PCB board.
